(19) United States
(12) Patent Application Publication
(10) Pub. No.: US 2026/0334420 A1
(43) Pub. Date: Oct. 29, 2026

(54) MILKING DEVICE COMPRISING A MILKING UNIT AND A HOUSING IN WHICH A VACUUM COMPONENT IS LOCATED

(71) Applicant: GEA Farm Technologies GmbH, Bönen (DE)

(72) Inventors: Thomas Troppmann, Sassenberg (DE); Markus Auburger, Lippstadt (DE); Uwe Feddermann, Warstein (DE); Jörg-A Lambke, Beckum (DE); Adib Matty, Essen (DE)

(21) Appl. No.: 18/997,394

(22) PCT Filed: Jul. 18, 2023
(86) PCT No.: PCT/EP2023/069900

§ 371 Date: Jan. 21, 2025

(30) Foreign Application Priority Data
Jul. 22, 2022 (DE) 20 2022 104 168.7

(51) Int. Cl. A01J 5/04; A01J 5/14

(52) U.S. Cl. CPC A01J 5/047; A01J 5/14

(57) ABSTRACT

The invention relates to a milking device comprising a milking unit, at least one vacuum component which is connected to the milking unit and has an inlet port and an outlet port, and a housing (10) with an interior delimited by walls, wherein the housing (10) has first and second openings. An inlet coupling sleeve (22.1, 22.2) with a duct extends through the first opening, partly into the interior. An outlet coupling sleeve (23.1, 23.2) with a duct extends through the second opening, partly into the interior. The vacuum component is located in the interior. The inlet port projects into the inlet sleeve and the outlet port projects into the outlet coupling sleeve.

The subject matter of the invention relates to a milking device having a milking unit.

In the following text, the invention is described in conjunction with a milking device for milking cows. It should be noted that the subject matter of the invention also relates, in particular, to milking devices for milking sheep, goats, llamas, camels, dromedaries, buffalo, mares, donkeys or yaks. The invention can be used both in fully automatic and in partially automatic milking devices.

In a dairy farm, use is made of numerous systems which are important for dairy farming and for milk production. A dairy farm may comprise a milking installation which has a plurality of milking stalls. Each milking stall is equipped with a milking device. A milking device has a milking unit. The milking unit comprises at least one teat cup which is connected to a milk transport line via a milk hose. Milking units are also known in which at least two teat cups are connected to a milk collecting tank in each case via a short milk hose, wherein the milk collecting tank is connected to the milk transport line via a long milk hose, optionally with a measuring vessel connected in between. Milking units are operated under predefined operating conditions, which are, for example, the milking vacuum or the frequency of a pulsator.

A milking installation has at least one so-called milk trap. The milk trap is connected to the milk line system. The milk trap is also connected to a vacuum system. The milked milk passes from the teat cups to the milk trap. The milk trap has an outlet which is connected to a pump such that the milked milk is discharged from the milk trap by means of the pump. In this regard, the milking installation can be subdivided substantially into two regions: a first region that carries a vacuum, and a second region that carries milk. The transition is formed in this case by the milk trap.

Raw milk is an important foodstuff and a raw material for the food industry. In order to protect consumers and for technical processability, it is necessary for the milk to meet both national and international quality requirements. To this end, there are corresponding national or international regulations which have to be complied with. Thus, for example, milk must not exhibit any abnormal sensory features. To achieve this, the udder of animals from which milk is obtained for consumption has to be cleaned at the start of the milking process. It is necessary here for thorough and complete cleaning to take place.

The compliance with prescribed hygienic standards is also important, in order to ensure a high milk quality. Therefore, it is necessary to clean not only the udders and teats of the animal, but also the components of the milking device. Cleaning may also involve disinfection of the components of the milking device. The cleaning process may be carried out by means of a fluid, in particular by means of water and cleaning and disinfecting or other additives.

It is known that after each cow has been milked, the milking unit is cleaned with water, a disinfectant solution and water again, and optionally dried with compressed air. This is so-called intermediate cleaning.

Both the milking as such and the cleaning process take place with the aid of vacuum. The milking device therefore has numerous vacuum components which have to be controlled accordingly. A vacuum component may be in particular a pulsator or a valve, including electrically actuated valves.

Since there are numerous vacuum components, which are subject to wear, it is necessary to replace these components at least on a regular basis, in order to maintain the functionality of the milking device and thus also of a milking installation having a multiplicity of milking devices.

Thus, it is known for vacuum components to be installed in a stall-related manner. This means that each milking stall, considered individually, has vacuum components that possibly need to be regularly maintained and/or replaced. This involves a considerable amount of work.

Against this background, the present invention is based on the objective of specifying an installation system for a milking device, which allows quicker and in particular tool-free replacement and/or installation of the vacuum components.

This object is achieved by a milking device according to the independent claim. Further advantageous refinements are the subject matter of the dependent claims.

The milking device according to the invention comprises a milking unit. The milking unit has, as mentioned at the beginning, at least one teat cup, which is connected directly or indirectly to a milk transport line. The number of teat cups depends on the type of animal to be milked. The teat cups may each be connected via a short milk hose to a milk collecting tank, which is connected to the milk transport line via a long milk hose.

The teat cup as such has a teat cup shell in which a teat rubber is arranged. The intermediate space located between the teat cup and the teat rubber is connected to a vacuum component, which is preferably a pulsator. The space between the rigid teat cup shell and the elastic teat rubber is alternately subjected to negative pressure and atmospheric pressure. As a result, an alternation between the suction and relief phase is achieved. A vacuum prevails in the milk hose connected to the teat rubber.

In order to generate the alternation between negative pressure and atmospheric pressure in the teat cup intermediate space, a so-called pulse line is connected to each teat cup, wherein the two pressures are switched between by means of corresponding valves. The valve is preferably an electronically switched valve which is switched according to the desired rhythm. It is known that, for example, a plurality of pulsators are connected in terms of signaling to a central control device such that pulsators work synchronously. In this kind of milking installation, the pulsators work synchronously, this being associated with considerable fluctuations in the negative pressure in the vacuum system of the milking installation.

Furthermore, pulsators are known which work alternately. In this kind of pulsator, the teat cup intermediate space of two teat cups of a milking unit are each placed under vacuum when atmospheric pressure is introduced into the teat cup intermediate spaces of the two other teat cups. These so-called alternating pulsators are preferred, since in this case the risk of the milking device, in particular the teat cups, falling off is considerably lower since two teat cups are each attached firmly to the teats of a cow.

Furthermore, it is known that the milking process as such is carried out substantially individually for each animal. This is associated with the fact that vacuum components comprised by the milking unit have to be provided separately in particular for each milking stall. This also means that the installation effort for installing a milking installation is considerable. Furthermore, vacuum components, which are subject to wear, have to be replaced at predefined intervals or as required. It is also necessary, in the event of a faulty vacuum component, for it to be possible to replace a vacuum component as quickly as possible, in order to avoid, for example, substantial vacuum failures.

A vacuum component has an inlet port and an outlet port. The designations inlet port and outlet port are used here and in the following text to differentiate the ports. This does not define a flow direction of a fluid, in particular of air. The same also goes for the use of the terms inlet sleeve and outlet sleeve. These are intended to express the fact that a sleeve that is assigned to the inlet port is referred to as an inlet sleeve. The same goes for the outlet sleeve. Where the term port is used, the information provided about the port relates to the inlet port and/or the outlet port. Where the term sleeve is used, the information provided about the sleeve relates to the inlet sleeve and/or outlet sleeve.

The milking device according to the invention has a housing, which has a delimited interior space. A wall of the housing has a first opening. An inlet sleeve, which has a channel, extends through the first opening. The inlet sleeve projects partially into the interior space of the housing. Furthermore, an outlet sleeve having a channel is provided, said outlet sleeve extending partially into the interior space through a second opening in the housing. The vacuum component arranged in the interior space is connected to the inlet sleeve and to the outlet sleeve. This is in particular a form- and/or force-fitting connection between the inlet port and the inlet sleeve and between the outlet port and the outlet sleeve.

The port is plugged into the sleeve. The configuration of the sleeve and of the port is chosen such that a vacuum-tight connection between the sleeve and the port is achieved. In particular, it is proposed here that the sleeve is formed in an elastic manner at least in the region into which the port projects. Such a configuration of the milking device according to the invention has the advantage that an installation system for vacuum components that is preferably tool-free, rapid and easy to handle is provided. The possibility is also created of achieving servicing and repair as far as possible without interrupting the use of the milking installation.

Preference is given to a milking unit in which the inlet sleeve and/or the outlet sleeve has a groove which projects into the rim of the first opening or of the second opening. As a result, the inlet sleeve and/or the outlet sleeve can be positioned. Preferably, the openings have an asymmetric cross section. The sleeve has, in the region of the groove, a correspondingly shaped cross section. As a result, the sleeve can be installed in the opening in an accurate position. It is also possible for the pairing of the first opening and inlet port and the pairing of the second opening and outlet port to have different cross-sectional shapes from one another, resulting in improved allocation of the inlet and outlet ports to the openings, this being advantageous for the installation of the vacuum component with the inlet and outlet sleeve.

A further advantage of such a configuration of the inlet sleeve and/or of the outlet sleeve can be considered to be that the pressure forces that arise during installation, i.e. during the connection of the vacuum component to the inlet and/or outlet sleeve, are introduced into the wall via the rim, and so slipping of the sleeve is avoided. This also applies when a vacuum component is removed from the housing. In this case, the tensile forces that act on the inlet and/or outlet sleeve are introduced into the wall.

Particular preference is given to a configuration in which the groove is delimited by an encircling inner collar that extends in a radial direction and by an encircling outer collar that extends in a radial direction, wherein the inner collar is arranged in the interior space. This has the result that an effective thickness of the sleeve is not reduced by the groove. Furthermore, the inner collar and/or the outer collar can be provided with a bevel, making it easier to install the inlet and/or outlet sleeve.

In order to increase the operational reliability, a further advantageous configuration proposes that a ratio of the radial extent of the outer collar to the radial extent of the inner collar is greater than 1, preferably greater than 1.1, in particular greater than 1.25. As a result, a relatively large contact surface of the outer collar is provided, and so, when the vacuum component is removed from the sleeve, the tensile force the vacuum component exerts on the sleeve during withdrawal of the port from the is transmitted into the wall.

Preference is given to a configuration in which the outer collar has an annular portion which is inclined in the direction of the inner collar. This configuration has the advantage that the sleeve is arranged in the opening in the wall with a certain preload. Furthermore, manufacturing tolerances both in the wall and in the sleeve itself can be compensated as a result, and so the sleeve can be held securely at the opening and on the wall.

In particular, a milking device is proposed in which the inlet sleeve has a first end located outside the interior space and a second end located inside the interior space.

The inlet sleeve has a channel, which extends from one end to the other end. The internal channel has, at least at the second end, a radially inwardly directed encircling bead. This increases security with regard to a vacuum-tight connection between the inlet port and the inlet sleeve. Preference is also given here to a configuration in which the outlet sleeve has a first end located outside the interior space and a second end located inside the space, wherein the channel has, at least at the second end, a radially inwardly directed encircling sleeve. The channel preferably has a stop, which creates a limit as to how far the port can be introduced into the channel. As a result, a defined installation position is also achieved. In particular, with regard to defined positioning of the vacuum component in the housing, it is proposed that the latter has positioning elements that determine the position of the vacuum component in the housing. To this end, the wall that has the openings preferably has at least one protrusion that forms a stop, such that, on installation of the vacuum component, while the ports are being inserted into the sleeves, the sleeves are not pushed out of the openings.

To simplify installation, it is proposed that the inlet port and/or the outlet port has an encircling recess formed in a manner corresponding to the bead. This also allows, during installation or during servicing and/or repair work, perceptible catching of the bead in the recess for the operator, thereby ensuring that the vacuum component has been installed technically perfectly.

To increase operational reliability, in particular to increase the vacuum-tightness, a further advantageous configuration proposes that the outlet or inlet port passes through an imaginary plane that is defined by the surface, facing the interior space, of the wall. This means that the inlet or outlet port, as seen in a section plane, extends into the wall. This has the result that the outlet or inlet port pushes a wall portion of the outlet or inlet sleeve against the rim of the first or second opening, with the result that effective clamping is achieved. This increases the tightness.

The vacuum component is preferably a pulsator.

Different vacuum components may be arranged in the housing. The vacuum components may be arranged in such a way that they are grouped in accordance with their functionality.

Preference is also given here to a configuration in which the vacuum component is a vacuum distributor having an inlet port and at least two outlet ports. The vacuum distributor may in this case have connections for, for example, valves, by means of which the inlet port and/or the two outlet ports can be opened or closed, that is to say actuated, individually or in groups.

If the vacuum component has more than two ports, the ports are preferably arranged such that at least one port is arranged in an offset manner with respect to the other ports. Offset means in this connection that not all of the ports lie on an imaginary straight line.

Particular preference is given to a configuration in which the sleeve is formed from an elastic material. As a result, and in particular as a result of the configuration of the connection between the sleeve and the port, acoustic decoupling is achieved. This is particularly advantageous when the vacuum component is a pulsator.

Further advantages of the invention are explained by way of the exemplary embodiment illustrated in the drawing, without the subject matter of the invention being limited to this exemplary embodiment.

In the drawing:

FIG. 1: schematically shows a milking stall having a milking device,

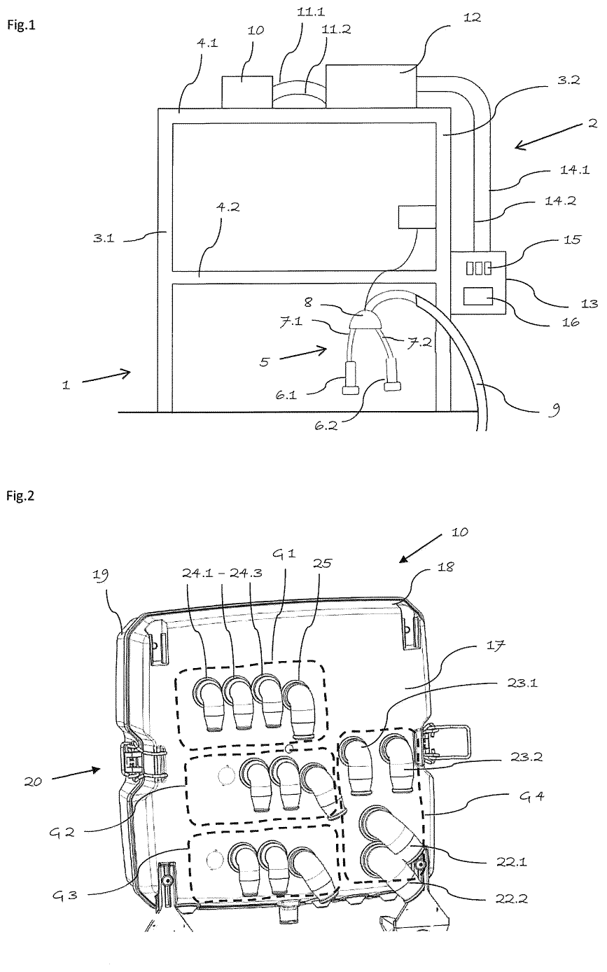

FIG. 2: shows a perspective rear view of a housing,

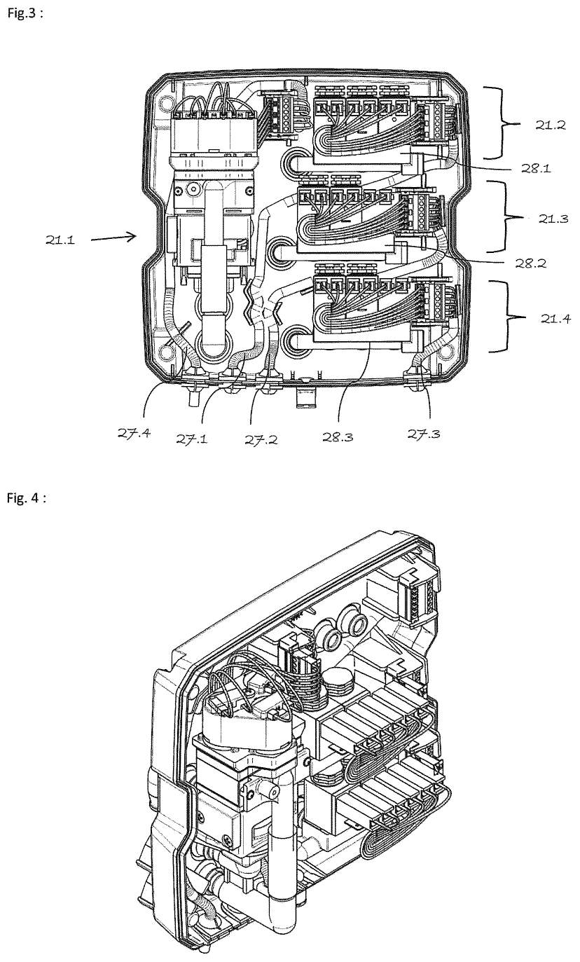

FIG. 3: shows a front view of the housing according to FIG. 1 without a cover,

FIG. 4: shows a perspective view of a second exemplary embodiment of a housing without a cover,

FIG. 5: shows a perspective view of a vacuum distributor having valves,

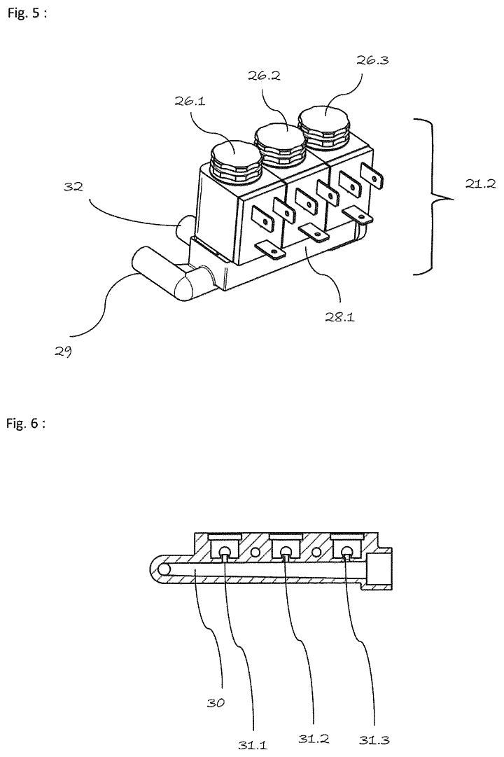

FIG. 6: shows the vacuum distributor according to FIG. 5 in section,

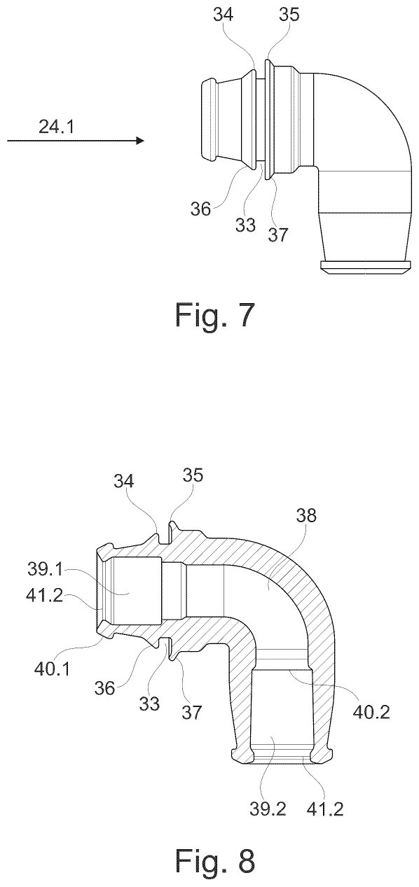

FIG. 7: shows a perspective view of an inlet sleeve,

FIG. 8: shows the inlet sleeve according to FIG. 7 in section,

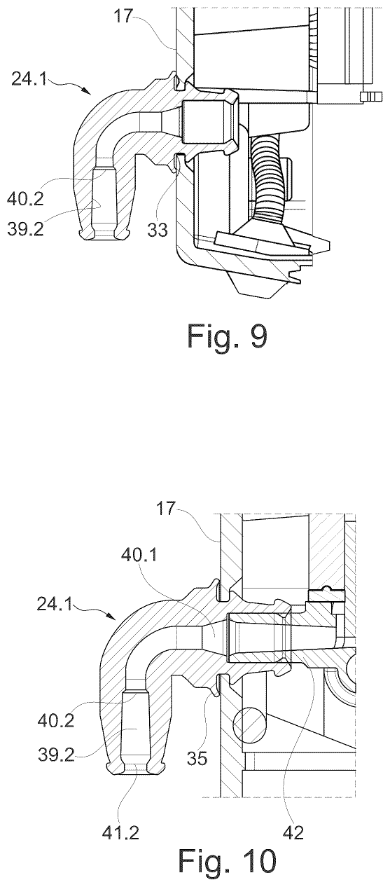

FIG. 9: shows an arrangement of an inlet sleeve in the housing and in the, and

FIG. 10: shows the arrangement according to FIG. 9 with a vacuum component.

FIG. 1 schematically illustrates a milking stall 1 for milking an animal, in particular a cow. The milking stall 1 may be an individual milking stall, a group milking stall or a milking stall on a milking carousel. The milking installation 1 is delimited by a lattice construction 2. The configuration of such a lattice construction 2 is independent of whether it is a matter of a milking stall or of a milking stall on a milking carousel, or an individual milking stall or a milking stall in a group milking parlor.

In the exemplary embodiment illustrated, the lattice construction has uprights 3.1, 3.2 which extend in a vertical direction. Further uprights (not illustrated) may also be present. Substantially horizontally extending pipes 4.1, 4.2 are connected to the uprights 3.1, 3.2. The pipes 4.1, 4.2 delimit the milking stall, where necessary, in the longitudinal direction of the milking stall and transversely to the longitudinal direction of the milking stall. Such a lattice construction may also be used as a fastening means for fastening further components that are located at the milking stall.

In the exemplary embodiment illustrated, the milking stall 1 has a milking unit 5. The milking unit 5 has teat cups 6.1, 6.2. In this regard, the milking stall is a milking stall for milking cows, wherein only two of the four teat cups are illustrated. The teat cups 6.1, 6.2 are each connected via a short milk hose 7.1, 7.2 to a milk collecting piece 8. The milk collecting piece 8, or the milk collecting tank, is connected to a milk transport line (not illustrated) via a milk hose 9.

The reference sign 12 identifies a housing of an electronic controller, located in the housing, for the milking stall and in particular for the milking device. The housing 12 of the electric controller is fastened to the pipe 4.1. In order to operate the milking stall, an operator terminal 13 is provided. The operator terminal 13 is connected via signal lines 14.1, 14.2 to the controller arranged in the housing 12. The operator terminal 13 has operating keys 15 by means of which commands can be input to the controller and/or information can be retrieved from the controller. The operating keys may also be keys by means of which individual operations are started and ended during the milking process. Thus, it is possible, for example, for there to be an operating key for operating the milking process, which is used to activate an automatic remover such that the attached teat cups are removed from the teat of the animal. To display information, the operator terminal has a display 16.

The electric controller, which is located in the housing 12, is connected via cables 11.1, 11.2 to a vacuum component or vacuum components arranged in the housing 10. For the sake of clarity, lines or pipes that carry vacuum or air have not been illustrated. The housing 10 is arranged on the pipe 4.1.

It is clear from the illustration according to FIG. 1 that an electronic controller is provided for an individual milking stall. This also goes for the vacuum components.

FIG. 2 shows a perspective view of the housing 10, looking towards a rear wall 17. The rear wall 17 is connected to an encircling rim 18. The rim 18 is connected to a hood-like cover 19. To releasably connect the hood-like cover 19 to the rim or the rear wall 17, corresponding connecting means 20 are provided, such that the cover 19 is releasably connected to the rear wall 17.

The rear wall 17, the rim 18 and the cover 19 delimit an interior space in which at least one vacuum component is arranged.

FIG. 3 shows an internal view of the housing 10. It is apparent from the illustration that four vacuum components 21.1-21.4 are arranged in the housing 10. The vacuum component 21.1 is a pulsator. The pulsator is connected to two inlet sleeves 22.1, 22.2. Furthermore, the pulsator is connected to two outlet sleeves 23.1, 23.2. The inlet sleeves 22.1, 22.2 and the outlet sleeves 23.1, 23.2 form a group G4 which is illustrated by way of dashed lines in FIG. 2. In the exemplary embodiment illustrated, the inlet sleeves 22,1, 22.2 are formed differently than outlet sleeves 23.1, 23.2. This is not necessarily the case. It is also possible for the inlet sleeves 22.1, 22.2 and the outlet sleeves 23.1, 23.2 to be formed identically. It is clear from the illustration according to FIG. 2 that the outlet sleeves 23.1, 23.2 are oriented differently than the inlet sleeves 22.1, 22.2, with the result that the risk of confusion of the connections at the rear wall 17 is intended to be avoided.

The vacuum components 21.2, 21.3 and 21.4 are each a vacuum distributor 28.1, 28.2 and 28.3. It is clear from the illustration according to FIG. 2 that the vacuum distributor 28.1 forms a group G1 and the vacuum distributor 28.2 forms a group G2 and the vacuum distributor 28.3 forms a group G3 of possible connections. In the exemplary embodiment illustrated, each vacuum distributor 28.1-28.3 is connected to three outlet sleeves 24.1-24.3. Furthermore, the vacuum distributor 28.1 is connected to an inlet sleeve 25. It is clear both from the illustration according to FIG. 2 and from the illustration according to FIG. 3 that the outlet sleeves 24.1-24.3 lie substantially on a line. The inlet sleeve 25 is arranged in a manner spaced apart therefrom. Each vacuum distributor 28.1, 28.2 and 28.3 has a corresponding inlet sleeve 25. The further groups G2 and G3 of vacuum components 21.2 and 21.3 are also formed in a corresponding manner.

It is clear in particular from the perspective view in FIG. 4 and from the illustration of the vacuum component 21.2 in FIGS. 5 and 6 that the vacuum component 21.2, in addition to the vacuum distributor 28.1, has a plurality of, in this case three, valves 26.1-26.3. The number of valves is by way of example here. The valves 26.1-26.3 are electrically actuable valves. The valves have corresponding contacts which are connected to corresponding signal lines which pass out of the housing 10 as cable bundles 27.1, 27.1 and 27.3. The same goes for the vacuum component 21.1 referred to as a pulsator.

A preferred configuration of a vacuum component 21.2 is illustrated in FIGS. 5 and 6. The vacuum component 21.2 has a vacuum distributor 28.1. Valves 26.1, 26.2 and 26.3 are connected to the vacuum distributor 28.1 in the exemplary embodiment illustrated.

The vacuum distributor 28.1 has an inlet port 28. The inlet port 29 is connected to a channel 30. From the channel 30 there extend feed lines 31.1-31.3, which are each fluidically connectable to an outlet port 32, wherein only the outlet port 32 is illustrated in FIG. 5. The feed lines 31.1-31.3 are able to be closed and opened by the corresponding valve 26.1 to 26.3.

An exemplary embodiment of an inlet sleeve 24.1 is illustrated in FIGS. 7 and 8.

In the exemplary embodiment illustrated, the inlet sleeve 24.1 is formed such that it has a deflection angle of about 90°. The inlet sleeve 24.1 has an encircling groove 33. The encircling groove 33 is delimited by an encircling inner collar 34 extending in a radial direction, and an encircling outer collar 35 extending in a radial direction. In the installed state of the inlet sleeve 24.1, the inner collar 34 is located in the housing. It is clear from the illustration according to FIGS. 7 and 8 that the inner collar 34 has an installation bevel 36, making it easier to introduce one end portion of the sleeve into the housing.

The outer collar 35 has an annular portion 37, which is inclined in the direction of the inner collar 34, bringing about a certain bracing of the outer collar 35 with the wall of the housing.

The inlet sleeve 24.1 has a continuous channel 38. The channel 38 has a first portion 39.1 in an end region of the inlet sleeve. Furthermore, the channel 38 has a second portion 39.2 at the opposite end. The shape of each particular portion 39.1 and 39.2 is formed such that it matches the form and shape of the port engaging in the particular region, specifically such that there is substantially no additional flow resistance in the installed state. The channel 38 has, in each particular portion 39.1, 39.2, a stop 40.1, 40.2 which creates a limit to how far a port can be introduced into the channel 38. As a result, a defined installation position is also achieved. In particular

[symbol]

The outlet sleeve is preferably formed in a manner corresponding to the inlet sleeve, with the result that the number of parts can be reduced.

FIG. 9 shows an inlet sleeve 24.1 in an installed state in the housing. It is clear from the illustration according to FIG. 9 that a rim of the opening projects into the groove 33. Preferably, the groove 33 is formed so as to have a width that is smaller than the corresponding wall thickness, resulting in bracing and thus a force- and form-fitting connection between the sleeve and the wall.

FIG. 10 shows an arrangement in which an inlet port projects into the portion 39.1.

Both the portion 39.1 and the portion 39.2 each have, in the exemplary embodiment illustrated, an encircling bead 41.1, 41.2, which projects radially inwardly into the channel 38. The port, as illustrated in FIG. 10, has a correspondingly formed groove, into which the bead 41.1 projects. The port extends preferably far enough into the sleeve that it passes through an imaginary plane of the wall.

### LIST OF REFERENCE SIGNS

1 Milking stall
2 Lattice construction
3.1, 3.2 Upright
4.1, 4.2 Pipe
5 Milking unit
6.1, 6.2 Teat cup
7.1, 7.2 Short milk hose
8 Milk collecting piece
9 Milk hose
10 Housing
11.1, 11.2 Cable
12 Housing
13 Operator terminal
14.1, 14.2 Signal line
15 Operating key
16 Display
17 Rear wall
18 Encircling rim
19 Cover
20 Connecting means
21.1-21.4 Vacuum component
22.1, 22.2 Inlet sleeve
23.1, 23.2 Outlet sleeve
25 Inlet sleeve
26.1-26.3 Valves
27.1-27.3 Cable bundle
28.1-28.3 Vacuum distributor
29 Inlet port
30 Channel
31.1-31.3 Feed line
32 Outlet port
33 Groove
34 Inner collar
35 Outer collar
36 Installation bevel
37 Portion
38 Channel
39.1, 3.2 Portion, end region
40.1, 40.2 Stop
41.1, 41.2 Bead
42 Outlet port

1. A milking device, comprising:
a milking unit;
at least one vacuum component which is connected to the milking unit and has an inlet port and an outlet port;
a housing which has an interior space delimited by walls, wherein the housing has first and second openings;
an inlet sleeve which has a channel and extends partially into the interior space through the first opening; and
an outlet sleeve which has a channel and extends partially into the interior space through the second opening,
wherein the vacuum component is arranged in the interior space, and
wherein the inlet port projects into the inlet sleeve and the outlet port projects into the outlet sleeve.

2. The milking device as claimed in claim 1, wherein the inlet sleeve and/or the outlet sleeve has a groove into which a rim of the first opening or of the second opening projects.

3. The milking device as claimed in claim 2, wherein the groove is delimited by an encircling inner collar that extends in a radial direction and by an encircling outer collar that extends in a radial direction, wherein the inner collar is arranged in the interior space of the housing.

4. The milking device as claimed in claim 3, wherein a ratio of a radial extent of the outer collar to a radial extent of the inner collar is greater than 1.0.

5. The milking device as claimed in claim 3, wherein the outer collar has an annular portion which is inclined in a direction of the inner collar.

6. The milking device as claimed in at claim 1, wherein the inlet sleeve and/or outlet sleeve has a first portion, outside the interior space, of an end region and a second portion, located inside the interior space of the housing, of an opposite end region, wherein the channel has, at least on the second portion, a radially inwardly directed encircling bead.

7. The milking device as claimed in claim 6, wherein the inlet sleeve and/or the outlet sleeve has a first end located outside the interior space and a second end located inside the interior space, wherein the channel has, at least at the second end, a radially inwardly directed encircling bead.

8. The milking device as claimed in claim 6, wherein the inlet port and/or the outlet port has a recess formed in a manner corresponding to the bead.

9. The milking device as claimed in claim 1, wherein the outlet port passes through an imaginary plane that is defined by a surface, facing the interior space, of the wall.

10. The milking device as claimed in claim 1, wherein the vacuum component comprises a pulsator.

11. The milking device as claimed in claim 1, wherein the vacuum component is a vacuum distributor having an inlet port and at least two outlet ports.
